(19) United States
(12) Patent Application Publication
(10) Pub. No.: US 2026/0206801 A1
(43) Pub. Date: Jul. 23, 2026

(54) A PROCESS AND COMPOSITION FOR PREPARING A HYDROLYZED LOW FAT COCONUT PRODUCT, USEFUL FOR EXAMPLE, AS A BEVERAGE OR AS A POWDER FOR DESERTS AND COOKING

(71) Applicant: SOCIÉTÉ DES PRODUITS NESTLÉ S.A., Vevey (CH)

(72) Inventors: Sakshi MITTAL, Gurugram (IN); Joydeep RAY, Gurugram (IN); Rohit UPADHYAY, Faridabad (IN); Madhavi WAGH, Maharashtra (IN); Seinn Lae WAING, Singapore (SG); Edwin ANANTA, Epalinges (CH); Ching Theng TAN, Johor Bahru (MY); Shreya MUKHERJEE, Singapore (SG)

(21) Appl. No.: 19/139,208

(22) PCT Filed: Dec. 4, 2023
(86) PCT No.: PCT/EP2023/084110

§ 371 Date: Jun. 13, 2025

(30) Foreign Application Priority Data
Dec. 14, 2022 (IN) 202211072127
Feb. 6, 2023 (EP) 23155149.0

(51) Int. Cl. A23L 5/20; A23L 19/00

(52) U.S. Cl. CPC A23L 5/25; A23L 19/09

(57) ABSTRACT

The present invention relates to a process and composition for preparing a hydrolyzed coconut product. The process of the present invention comprises the steps of enzymatically hydrolyzing a wet pressed coconut cake and liquefying the wet pressed coconut cake. Advantageously, the subject matter of the present invention allows it, for example, to use side streams of coconut processes i.e., wet pressed coconut cake and coconut water or water to prepare a low fat containing hydrolyzed coconut product.

The present invention relates to a process and composition for preparing a hydrolyzed coconut product. The process of the present invention comprises the steps of enzymatically hydrolyzing a wet pressed coconut cake and liquefying the wet pressed coconut cake. Advantageously, the subject matter of the present invention allows it, for example, to use side streams of coconut processes i.e., wet pressed coconut cake and coconut water or water to prepare a low fat containing hydrolyzed coconut product.

Coconut milk-based beverages are sold and consumed worldwide. Natural coconut milk has about 15-55% fat content; however, when attempting to develop a low-fat proposition (e.g., ready to drink (RTD) beverage) by diluting it with diluent like coconut water or normal water, the overall consumer experience reduces to greater extent. In addition, the amount of fat and sugar makes it industrially more difficult to dry it, particularly to spray dry it, into a smooth and non-sticking powder.

Wet pressed coconut cake is obtained as a side stream of coconut milk extraction, where the grated coconut kernel is mixed with water and pressed to separate the liquid fraction called coconut milk which mainly comprises fat. The left-over mass is called wet pressed coconut cake which has a fat content of 1 to 25%. Consumers today are keener to consume sensorially indulgent products but at the same time are concerned about consuming high fat containing products.

WO2020239521 described in this respect a coconut milk powder using coconut milk and coconut flour to prepare an aqueous solution, which is spray dried to obtain the coconut milk powder. The use of coconut flour as raw material is relatively expensive and can lead to low coconut flavoured product on the sensory dimension having a gritty and sandy mouthfeel perception.

Hence, there is a clear need in the art and industry to find alternatives and better solutions for producing low-fat containing coconut-based product which could be applied to various applications.

The objective of the present invention is to improve the state of the art or at least provide an alternative solution to provide a process for making a low-fat containing coconut product that can be used for cooking sauces, RTD beverages, yogurts, baking deserts or for preparing a dried coconut powder, that has an excellent taste and texture profile, using lesser processing steps and therefore little energy and/or generates little CO₂ during production, largely valorises coconut side streams and is economically reasonable to produce such a product.

The inventors were surprised to see that the objective of the present invention could be achieved by the subject matter of the independent claims. The dependent claims further develop the idea of the present invention.

Accordingly, the present invention provides a process for making a low-fat coconut product comprising the steps of:
a) Adding coconut water or water or a combination thereof to a wet pressed coconut cake, wherein the wet pressed coconut cake has a moisture content of 20 to 55 weight-% (based on total composition of the wet pressed coconut cake);
b) enzymatically hydrolyzing the aqueous mixture of wet pressed coconut cake;
c) liquefying the aqueous mixture of wet pressed coconut cake;
   wherein the enzymatic hydrolysis is carried out by an enzyme selected from a combination of cellulases, mannanases, beta-glucanases and xylanases.

In an embodiment, the present invention provides a process for making a low-fat coconut product comprising the steps of:
a) Adding coconut water or water or a combination thereof to a wet pressed coconut cake, wherein the wet pressed coconut cake has a moisture content of 20 to 55 weight-% (based on total composition of the wet pressed coconut cake);
b) enzymatically hydrolyzing the aqueous mixture of wet pressed coconut cake;
c) liquefying the aqueous mixture of wet pressed coconut cake;
d) thermal treatment of the hydrolyzed and liquefied wet pressed coconut cake;
   wherein the enzymatic hydrolysis is carried out by an enzyme selected from a combination of cellulases, mannanases, beta-glucanases and xylanases.

In an embodiment, the present invention provides a process for making a low-fat coconut product comprising the steps of:
a) Adding coconut water or water or a combination thereof to a wet pressed coconut cake, wherein the wet pressed coconut cake has a moisture content of 20 to 55 weight-% (based on total composition of the wet pressed coconut cake);
b) enzymatically hydrolyzing the aqueous mixture of wet pressed coconut cake;
c) liquefying the aqueous mixture of wet pressed coconut cake;
d) thermal treatment of the hydrolyzed and liquefied wet pressed coconut cake;
   wherein the enzymatic hydrolysis is carried out by an enzyme selected from a combination of cellulases, mannanases, beta-glucanases and xylanases; and wherein the process does not include a grinding or pulverization or fermentation step of the wet pressed coconut cake.

In an embodiment, the present invention provides a process for making a low-fat coconut product comprising the steps of:
a) Adding coconut water or water or a combination thereof to a wet pressed coconut cake, wherein the wet pressed coconut cake has a moisture content of 20 to 55 weight-% (based on total composition of the wet pressed coconut cake);
b) enzymatically hydrolyzing the aqueous mixture of wet pressed coconut cake;
c) liquefying the aqueous mixture of wet pressed coconut cake;
d) thermal treatment of the hydrolyzed and liquefied wet pressed coconut cake;
   wherein the enzymatic hydrolysis is carried out by an amount of 0.2 to 5 weight-% (based on aqueous mixture), preferably from 0.5 to 3 weight-% (based on aqueous mixture) is of a combination of enzymes selected from the group consisting of cellulases, mannanases, beta-glucanases and xylanases.

In an embodiment, the present invention provides a process for making a low-fat coconut powder product comprising the steps of:
a) Adding coconut water or water or a combination thereof to a wet pressed coconut cake, wherein the wet pressed coconut cake has a moisture content of 20 to 55 weight-% (based on total composition of the wet pressed coconut cake);
b) enzymatically hydrolyzing the aqueous mixture of wet pressed coconut cake;
c) liquefying the aqueous mixture of wet pressed coconut cake;
d) spray drying the hydrolyzed and liquefied wet pressed coconut cake;
   wherein the enzymatic hydrolysis is carried out by an enzyme selected from a combination of cellulases, mannanases, beta-glucanases and xylanases.

In an embodiment, the present invention provides a process for making a low-fat coconut powder product comprising the steps of:
a) Adding coconut water or water or a combination thereof to a wet pressed coconut cake, wherein the wet pressed coconut cake has a moisture content of 20 to 55 weight-% (based on total composition of the wet pressed coconut cake);
b) enzymatically hydrolyzing the aqueous mixture of wet pressed coconut cake;
c) liquefying the aqueous mixture of wet pressed coconut cake;
d) spray drying the hydrolyzed and liquefied wet pressed coconut cake;
   wherein the enzymatic hydrolysis is carried out by an enzyme selected from a combination of cellulases, mannanases, beta-glucanases and xylanases; and wherein the process does not include a grinding or pulverization or fermentation step of the wet pressed coconut cake.

As used in this specification, the words “comprises”, “comprising”, and similar words, are not to be interpreted in an exclusive or exhaustive sense. In other words, they are intended to mean “including, but not limited to”.

The present inventors were surprised to see that the subject matter of the present invention allows it to
reduce the costs of production of a low-fat coconut product as compared to the production of a coconut product based on coconut milk and coconut flour;
obtain a low-fat coconut milk which has superior mouthfeel, taste and texture;
avoid overprocessing by using unprocessed ingredients which saves processing energy and CO₂ for the extraction of coconut milk;
solubilization of the insoluble cakes by enzymatic hydrolysis which increases mouthfeel, viscosity and aroma thereby maintaining comparable sensory profile even at low fat when compared with regular high fat coconut milk;
less acidic taste profile;
avoid pre-processing steps as grinding or pulverization or fermentation of the wet pressed coconut cake;
single-step hydrolysis achieved by using a combination of 4 enzymes;
almost completely valorize coconut kernels avoiding unnecessary raw materials losses;
replace maltodextrin by enzymatic hydrolysis of intrinsic coconut cakes which are then used as a carrier for spray drying;
achieve a very pleasant taste and mouthfeel as compared to the combination of coconut milk and coconut flour which can result in the perception of sandiness inside the mouth during consumption.

For example, the process of the present invention showed the above-described unexpected benefits when compared to processes of making coconut products of the prior art, for example made from coconut milk and coconut flour.

The term ‘wet pressed coconut cake’ refers to a mass that remains after extracting coconut milk by pressing grated pulp of a mature coconut. Typically, the pressed coconut cake is dried off to be sold as coconut flour. Typically, the wet pressed coconut cake has about 5 to 25 weight-% (based on total composition of the wet pressed coconut cake) fat, 1 to 10 weight-% (based on total composition of the wet pressed coconut cake) protein, 3 to 10 weight-% (based on total composition of the wet pressed coconut cake) insoluble fibers, and a moisture content of 20 to 55 weight-% (based on total composition of the wet pressed coconut cake).

The process of the present invention allows it to use wet pressed coconut cake as starting material. As it is a side stream of coconut processing (pressing of coconut meat), it can be less expensive than coconut milk. In an embodiment wet pressed coconut cake has a particle size of about 0.1-1 cm and a thickness of about 0.5-2.5 mm.

In an embodiment the low-fat coconut product in accordance with the present invention has a coconut fat content from 1 to 20 weight-% (based on total low-fat coconut product), preferably from 1 to 13 weight-%, preferably from 1 to 10 weight-%, preferably from 6 to 13 weight-%, preferably from 6 to 10 weight-% (based on total low-fat coconut product).

The process of the present invention allows it to make a low-fat coconut product, it can be a healthy substitute for traditional coconut milk without much compromising on taste, flavour, and mouthfeel.

Avoiding using more processed ingredients such as coconut milk and coconut flour as staring material also allows it to save processing energy and CO₂ emissions.

In addition, water or coconut water or a combination thereof is added to facilitate the enzymatic hydrolysis. As the wet pressed coconut cake and coconut water or water or a combination thereof is used for the process of the present invention, the side streams of coconut is completely valorized. If the coconut is pre-treated by dehusking the coconuts exocarp, mesocarp and endocarp and by testa removal, no more plant material is not used than one would also not consume if one eats a coconut as it is. Unnecessary raw material losses are avoided.

In an embodiment before adding the enzymes 20 to 90 weight-% of added coconut water or water or a combination thereof are added to 10 to 80 weight-% of wet pressed coconut cake, preferably 30 to 70 weight-% of added coconut water or water or a combination thereof are added to 30 to 70 weight-% of wet pressed coconut cake, preferably 35 to 65 weight-% of added coconut water or water or a combination thereof are added to 35 to 65 weight-% of wet pressed coconut cake, preferably 40 to 60 weight-% of added coconut water or water or a combination thereof are added to 40 to 60 weight-% of wet pressed coconut cake.

Remarkably, many coconut RTD products are high in fat. By using the wet pressed coconut cake and by enzymatically treating the wet pressed coconut cake, the present inventors were surprised to see that the despite the low fat in product, it exhibited good mouthfeel and flavor. Without wishing to be bound by theory, the inventors presently believe that the enzymes hydrolyze the intrinsic coconut cakes, which in turn contributes to viscosity, mouthfeel and flavor.

Even further, remarkably, the product obtained by the process of the present invention was found to achieve an improved taste and mouthfeel than prior art compositions. For example, a more intense sweetness, coconut aroma and the absence of a sandy texture is observed in the product of the present invention and when using the process of the present invention.

The inventors believe that the hydrolyzed coconut fibers that are already present in the wet pressed coconut cake will serve well as a carrier material for spray drying, avoiding the need for maltodextrin or for coconut flour.

Hence, in one embodiment of the present invention, dried coconut powder is free from maltodextrin and/or starch.

In one advantageous embodiment of the present invention the dried coconut powder is made from wet pressed coconut cake.

After hydrolysis, the low-fat coconut product may have particle size distribution of 1 to 1000 μm, 10 to 900 μm, 10 to 800 μm, 10 to 700 μm, 10 to 600 μm, 10 to 500 μm, 10 to 400 μm, 10 to 300 μm, 10 to 200 μm, or 10 to 100 μm.

Additionally, or alternatively, the dried coconut powder in accordance with the present invention, may have a particle size with a D90 value of less than 1000 μm, less than 900 μm, less than 800 μm, less than 700 μm, less than 600 μm, less than 500 μm, less than 400 μm, less than 300 μm, less than 200 μm, or less than 100 μm. D90 means that 90% of the particles are smaller than this value.

Particle size and particle size distribution is measured according to ISO 13320:2009.

The following emulsifiers may be used: sodium caseinate, acacia gum, xanthan gum, guar gum, lecithin, monoglycerides, plant proteins such as pea proteins, soy proteins, fava bean proteins, rice proteins, pectins such as sugar beet pectin, citrus pectin, apple pectin, saponins. In a preferred embodiment, the emulsifier may be selected from the group consisting of sodium caseinate or pea protein.

Alternatively, or additionally the following acidity regulators may be used: trisodium phosphate, sodium bicarbonate, potassium carbonate, calcium hydroxide. In a preferred embodiment, the acidity regulator may be selected from the group consisting of trisodium phosphate or sodium bicarbonate.

Additionally, or alternatively, the hydrolyzed wet pressed coconut cake product in accordance with the present invention, for example in liquid form, may have a viscosity in the range of 30 to 200 cP, for example 40-100 cP. The cP can be recalculated to 1 cP=10⁻³ Pa·s. In an embodiment the hydrolyzed coconut product in accordance with the present invention, for example in liquid form, may have a viscosity in the range of 0.05 to 0.3 Pa·s, for example 0.1-0.2 Pa·s. Viscosity is measured according to ISO 11443:2021 using capillary and slit-die rheometers (device: Brookfield viscometer, RV-02 Spindle number at 200 rpm) The cake present in hydrolysed wet pressed coconut product may comprise at least 90 weight-% (based on dry weight) of soluble cake, for example at least 95 weight-% (based on dry weight) of soluble cake.

The cake content of the composition of the present invention appears to be essential for the mouthfeel and superior taste properties of the product of the present invention.

The composition of the present invention may also comprise added cake for a low-fat coconut powder, for example selected from the group consisting of pectins, citrus cakes, apple cakes, acacia gum, xanthan gum, guar gum or combinations thereof. The added cake may be used, for example, to stabilize the emulsion before drying.

It is preferred that the composition of the present invention contains as little cake added from other sources as possible. Hence, in one embodiment of the present invention, the dried coconut powder comprises cake only from coconut. In one further embodiment of the present invention, the dried coconut powder comprises no added cake.

The moisture content of the low-fat coconut powder is important. A too high-water content will have negative consequences for storage times and powder properties, while a too low water content may have negative consequences for the reconstitution of the powder in liquids. Accordingly, the inventors propose that the dried coconut powder in accordance with the present invention may have a moisture content in the range of 0. weight-% to 10 weight-% (based on coconut powder), preferably from 0.5 to 3 weight-% (based on coconut powder).

As consumers expect a coconut product to have a very high coconut content, the dried coconut powder of the present invention may comprise at least 90 weight-% (based on dry weight) of coconut, at least 95 weight-% coconut, at least 98 weight-% (based on dry weight) of coconut or may consist of coconut.

Features described for the product of the present invention above may apply and may be combined with features described for the process of the present invention. Enzymatic hydrolysis may be carried out by an amount of 0.2 to 5 weight-% (based on aqueous mixture), preferably from 0.2 to 3 weight-%, preferably from 0.5 to 3 weight-% (based on aqueous mixture) of an enzyme mixture. The enzyme mixture may be selected from a combination of the group consisting of cellulases, mannanases, beta-glucanases and xylanases. In an embodiment, enzyme with endo-beta-1,4-mannanase activity and/or endo-beta-1,4-glucanase activity may be used, preferably enzymes with endo-beta-1,4-mannanase activity and endo-beta-1,4-glucanase activity may be used.

Further useful are enzymes with beta-glucanase and/or xylanase activity, preferably enzymes with beta-glucanase and xylanase activity. For example, the inventors have obtained good results with ROHALASE® GMP and with FoodPro®, both commercially available from specialist suppliers (AB Enzymes, Darmstadt, Germany and IFF Health and Biosciences, Brabrand, Denmark; respectively).

In accordance with the present invention the hydrolysis and the liquefaction of the wet pressed coconut cake may be carried out sequentially and/or simultaneously.

In an embodiment the hydrolysis is carried out for a time range between 20 minutes to 5 hours, preferably between 30 min to 180 min, preferably between 30 min to 120 min.

In an embodiment the hydrolysis is carried out at a temperature in the range between 40 to 70° C., preferably between 40 to 65° C., preferably between 40 to 60° C., preferably between 45 to 60° C.

It may be advantageous, if the enzyme or the enzyme mixture is deactivated after hydrolysis. For example, the enzyme or the enzyme mixture may be deactivated after the hydrolysis by thermal treatment. The deactivation may be carried out in a batch system or in a continuous system. Such a thermal treatment may be carried out, for example, for about 10 minutes at 85° C. in a batch system, or for about 20 seconds at 90° C., preferably 5 seconds at 84° C. in a continuous system.

It may be preferred if the hydrolyzed wet pressed coconut cake is liquefied. Such liquefication may be carried out by enzymatic treatment, for example, and may be carried out after hydrolyzing the wet pressed coconut cake and/or simultaneously while hydrolyzing the wet pressed coconut cake. For example, the hydrolyzed wet pressed coconut cake may be liquefied by enzymatic treatment. Liquefaction may be the process of rendering solid components liquid by their partial or total enzymatic hydrolysis. Thermostable enzymes may be used as this process may be carried out at elevated temperatures. Partial hydrolysis not only reduces viscosity but may also prevent retrogradation upon further cooling.

The hydrolyzed and liquefied wet pressed coconut cake may be spray dried, for example by an industrial or semi-industrial spray dryer. Spray drying is a preferred drying process when it comes to drying large industrial quantities of an aqueous slurry into a powder in an economic way. Preferably, spray drying is done at a temperature from 110° C. to 180° C. This allows on one hand to efficiently dry the composition into a powder, and on the other hand not to overheat the composition in order to prevent or minimize burning and other deteriorating effects such as undesired Maillard reactions.

Those skilled in the art will understand that they can freely combine all features of the present invention disclosed herein. In particular, features described for the product of the present invention may be combined with the use of the present invention and vice versa. Further, features described for different embodiments of the present invention may be combined. In particular, features described with respect to the product of the present invention may be combined with the process of the present invention and vice versa.

Although the invention has been described by way of example, it should be appreciated that variations and modifications may be made without departing from the scope of the invention as defined in the claims.

Furthermore, where known equivalents exist to specific features, such equivalents are incorporated as if specifically referred in this specification. Further advantages and features of the present invention are apparent from the figures and examples.

### EXAMPLES

### Examples 1 to 10: Preparation of a Coconut Product in Accordance with the Present Invention

Wet pressed coconut cake was appropriately mixed with diluent(s) selected from coconut water, normal water or a combination thereof. For hydrolysis, the resultant mixture was preheated for 5 minutes by direct steam injection to heat the coconut cake up to 60° C. Subsequently, 1 weight-% of FoodPro® CBL (Dupont-Danisco, NY, United States; enzyme combination of beta glucanase and cellulase) and 1 weight-% of Rohalase® GMP (AB Enzymes, Darmstadt, Germany; enzyme combination of mannase and xylanase) were respectively added to the heated coconut cake which has a pH range of 5.0-6.0 and temperature of 60° C. for 50-90 minutes under 50% agitation and 30% shear enabled complete the liquefaction of the coconut cakes/coconut cake. The hydrolyzed coconut cakes (or hydrolysed coconut cake slurry thus obtained) were then heat treated in a tubular heat exchanger for 20 seconds at 90° C. 10 internal experienced panellists were used to rate the sensory attributes of the hydrolysed obtained product with a score range between 0 to 7. The following amounts of wet pressed coconut cake and coconut water or water or a combination thereof are used before adding the enzymes as shown above:

| | Ex. 1 | Ex. 2 | Ex. 3 | Ex. 4 | Ex. 5 | Ex. 6 |
|---|---|---|---|---|---|---|
| Wet pressed coconut cake | 60 | 60 | 60 | 50 | 50 | 50 |
| (weight-%) | | | | | | |
| Coconut water (weight-%) | 40 | — | 20 | 50 | — | 25 |
| Water (weight-%) | — | 40 | 20 | — | 50 | 25 |
| Fat (weight-%) | 9.3 | 9.3 | 9.3 | 7.2 | 7.2 | 7.2 |
| Viscosity (cP) | 85 | 84 | 85 | 81 | 80 | 80 |
| Mouthfeel | 7 | 7 | 7 | 7 | 7 | 7 |
| Taste | 7 | 5 | 6 | 6 | 4 | 5 |
| Aroma | 7 | 5 | 6 | 6 | 4 | 5 |

| | Ex. 7 | Ex. 8 | Ex. 9 | Ex. 10 |
|---|---|---|---|---|
| Wet pressed coconut cake | 40 | 40 | 40 | 12 |
| (weight-%) | | | | |
| Coconut water (weight-%) | 60 | — | 30 | 88 |
| Water (weight-%) | — | 60 | 30 | — |
| Fat (weight-%) | 6.2 | 6.2 | 6.2 | 1.7 |
| Viscosity (cP) | 74 | 73 | 73 | 41 |
| Mouthfeel | 6 | 6 | 6 | 3 |
| Taste | 5 | 3 | 4 | 2 |
| Aroma | 5 | 3 | 4 | 2 |

### Example 11: Viscosity, Total Solids and Particle Size Distribution

The viscosity, total solids and particle size of the product in accordance with the present invention was assessed. These parameters such as viscosity, total solids and particle size distribution may play a key role when spray drying the composition. Before spray drying, the tested coconut product of the present invention had a viscosity, total solids, and particle size distribution of 35 to 150 cP at 55° C., 5 to 20%, and 1 to 1000 μm, respectively.

### Example 12: Dried Low-Fat Coconut Powder

Following the process of example 1, a dried coconut powder has been obtained by homogenization of the hydrolyzed coconut cake at 250 bars and heat treated in a tubular heat exchanger for 20 seconds at 90° C. Subsequently, the slurry was spray dried on an Egron line, resulting in a coconut milk powder.

### Comparison Example 13: Further Comparison Examples Using Only FoodPro® or Rohalase®

Enzymatically hydrolyzed wet pressed coconut cake produced as described in example 1 with the difference that only FoodPro® CBL (Dupont-Danisco, NY, United States; enzyme combination of beta glucanase and cellulase) or Rohalase® GMP (AB Enzymes, Darmstadt, Germany; enzyme mannase and xylanase) has been used instead of a combination of FoodPro® and Rohalase®. In this either case, the obtained comparison products are not a smooth homogenous product as fiber particles would remain after sieving. When tasted there is a gritty mouthfeel due to the remaining cake particles. Examples 1 to 10 have a no grit mouthfeel as a better hydrolysis take place using the combination of enzymes according to the invention having less remaining particles. In addition, the obtained viscosity is not appropriate for spray drying and it was more viscous with visible gritty particles as compared to one obtained for hydrolyzed wet pressed coconut cake using combination of FoodPro® and Rohalase® (example 1).

### Example 14: Extended Application as Non-Dairy Base in Plant Based and Vegan Formulations

The low-fat coconut product can be used to make different ready-to-use products such as, but not limited to, condensed coconut milk, cooking sauces, dairy and/or plant based RTD beverages (such as malted, cereal based, coffee-based, dairy protein and plant protein based), yogurts, baking deserts, and non-dairy creamers.

### Comparison Example 15: Further Comparison Example without Mannase Activity

Enzymatically hydrolyzed wet pressed coconut cake produced as described in example 1 with the difference that only the enzyme combinations selected from group consisting of beta-glucanase, cellulase and hemi-cellulase has been used where specific mannanase activity is absent.

| | Comparative Ex. 15 |
|---|---|
| Wet pressed coconut cake (weight-%) | 40 |
| Coconut water (weight-%) | 60 |
| Water (weight-%) | — |
| Fat (weight-%) | 6.2 |
| Viscosity (cP) | >150 |
| Mouthfeel | 2 |
| Taste | 2 |
| Aroma | 2 |

In this case, the obtained comparison product is not a smooth homogenous product as fiber particles would still remain after sieving. When tasted there is a gritty mouthfeel due to the remaining fibrous particles. Examples 1 to 10 have a no grit mouthfeel as a better hydrolysis take place using the combination of enzymes according to the invention having less remaining particles. In addition, the obtained viscosity is not appropriate for spray drying and it was more viscous with visible gritty particles as compared to one obtained for hydrolyzed wet pressed coconut cake using combination of FoodPro® and Rohalase® (example 1).

1: A process for making a low-fat coconut product, the process comprising:
a) adding coconut water or water or a combination thereof to a wet pressed coconut cake to form an aqueous mixture, wherein the wet pressed coconut cake has a moisture content of 20 to 55 weight-% (based on total composition of the wet pressed coconut cake);
b) enzymatically hydrolyzing the aqueous mixture of the wet pressed coconut cake;
c) liquefying the aqueous mixture of the wet pressed coconut cake;
wherein the enzymatic hydrolysis is carried out by an enzyme selected from the group consisting of cellulases, mannanases, glucanases xylanases and combinations thereof.

2: The process according to claim 1, wherein the low-fat coconut product has a fat content of 1-20 weight-%.

3: The process according to claim 1, wherein the amount of the coconut water or water or combination thereof before adding the enzyme is between 20 to 90 weight-% and the amount of the wet pressed coconut cake before adding the enzyme is between 10 to 80 weight-%.

4: The process according to claim 1, wherein the in the enzymatic hydrolysis is in an amount of 0.2 to 5 weight-%, (based on the aqueous mixture).

5: The process according to claim 1, wherein the enzymatic hydrolysis is carried out at a temperature between 40 to 70° C. for 30 to 180 min.

6: The process according to claim 1, wherein the low-fat coconut product after step b) has a viscosity between 30 to 150 cP.

7: The process according to claim 1, wherein the enzyme is deactivated by thermal treatment after the enzymatic hydrolysis.

8: The process according to claim 1, wherein the process does not include a grinding or pulverization or fermentation step of the wet pressed coconut cake.

9: The process according to claim 1, wherein the low-fat coconut product comprises fiber only from coconut.

10: The process according to claim 1, wherein the low-fat coconut product after the enzymatic hydrolysis has a particle size distribution of 1 to 1000 μm.

11: The process according to claim 1, wherein the wet pressed coconut cake after the enzymatic hydrolysis and the liquefying is spray dried by an industrial or semi-industrial spray dryer to obtain a dried low-fat coconut powder.

12: The process according to claim 11, wherein the dried low-fat coconut powder is free from maltodextrin and/or starch.

13: The process according to claim 11, wherein the dried coconut powder has a moisture content in the range of 0.40 weight-% to 10 weight-%.

14: The process according to claim 11, wherein the dried coconut powder comprises at least 90 weight-% coconut.

15: A composition obtainable by the process of claim 1, the composition comprising 1 to 20 weight-% of fat (based on total composition), 0.5 to 1.5 weight-% (based on total composition) of protein, 3 to 8 weight-% (based on total composition) of carbohydrates,
wherein the composition has an amount of total solids between 5 to 30 weight-% (based on total composition).

16: The process according to claim 1, wherein the low-fat coconut product has a fat content of 1-13 weight-%.

17: The process according to claim 1, wherein the enzyme in the enzymatic hydrolysis is in an amount of 0.5 to 3 weight-% based on the aqueous mixture.

18: The process according to claim 1, wherein the low-fat coconut product after step b) has a viscosity between 35 to 100 cP.

19: The process according to claim 11, wherein the dried coconut powder consists of coconut.

20: The process according to claim 1, wherein the enzyme is a combination of at least two enzymes selected from the group consisting of cellulases, mannanases, glucanases, xylanases and combinations thereof.
